(19) United States
(12) Patent Application Publication
(10) Pub. No.: US 2013/0020261 A1
(43) Pub. Date: Jan. 24, 2013

(54) FILTERING METHOD OF WATER TO BE TREATED

(71) Applicants: Tomoki Kawagishi, Toyohashi-shi (JP); Xiangji Sun, Tokyo (JP)

(72) Inventors: Tomoki Kawagishi, Toyohashi-shi (JP); Xiangji Sun, Tokyo (JP)

(73) Assignee: Mitsubishi Rayon Co., Ltd., Tokyo (JP)

(21) Appl. No.: 13/634,570

(22) PCT Filed: Mar. 3, 2011
(86) PCT No.: PCT/JP11/54893

§ 371 Date: Oct. 12, 2012

(30) Foreign Application Priority Data
Mar. 15, 2010 (JP) 2010-057906

(51) Int. Cl. C02F 1/00; B01D 61/20; B01D 61/14

(52) U.S. Cl. 210/650

(57) ABSTRACT

A filtering method of water to be treated including: performing air diffusion from air diffusing units, while the water to be treated is processed with a filtering process using a membrane unit, wherein the filtering process is an intermittently performing filtering process, the membrane unit has two or more separation membrane modules, a membrane surface of the separation membrane modules has a flat shape and extends along a vertical direction, two or more air diffusing units are arranged in a lower-side direction of the membrane unit, the air diffusing units each has one or more air diffusing pipes, and when air is ejected from the air diffusing units, the air diffusing unit which ejects air is switched per a constant air diffusing time t₁ so as to allow only one air diffusing unit to eject air, and the air diffusing time t₁ is from 90 seconds to 300 seconds.

### BACKGROUND OF THE INVENTION

1. Field of the Invention

The present invention relates to a filtering method of water to be treated using a membrane unit that includes separation membrane modules.

Priority is claimed on Japanese Patent Application No. 2010-057906, filed Mar. 15, 2010, the content of which is incorporated herein by reference.

2. Description of Related Art

In a process of organic sewage water, a method of separating solid and liquid after the sewage water undergoes a biological treatment by an active sludge is widely practiced. As the method of separating solid and liquid, a natural sinking method in a sinking tank and membrane separation method are known.

In the membrane separation, the filtering time is long so that the solid content or the like that is included in the water to be treated is accumulated on the membrane surface and the filtering differential pressure is increased. Thus, usually, air diffuses from the lower-side direction of the membrane and the membrane surface is cleaned by a mixed flow of air and liquid. However, air amount that is required to clean the membrane surface becomes large, resulting in an increase in the cost of the sewage water process.

As a method of decreasing the air amount that is required to clean the membrane surface, Patent Document 1 discloses a method of switching the diffused air in the membrane cleaning between a high flow amount and a low flow amount that is ½ or less of the high flow amount in a repeating period of a continuous time of 120 seconds or less.

### DOCUMENTS OF RELATED ART

### Patent Document

[Patent Document 1] Japanese Patent No. 3645814.

However, in a case where the water to be treated includes the active sludge, since there are many cases where the concentration of the active sludge concentration is high, in the method disclosed in Patent Document 1, it is required that the air diffusing of the high flow amount and the air diffusing of the low flow amount are switched at a high frequency (for example, intervals of 10 seconds or less) and that the accumulation of the sludge on the membrane surface is thereby prevented. However, it is necessary that the blower for air diffusing repeats the operation and the stopping at a high frequency or that a valve for changing the flow passages is switched so as to switch the air flow amount at a high frequency. Generally, since the blower requires a large power consumption amount when it starts, the power consumption amount increases in the total membrane separation if the operation and the stopping are repeated at a high frequency. If the operation and the stopping of the blower or the switching of the valve are repeated at a high frequency, it is a cause of expediting the damage to the blower or the valve. In a method as disclosed in Patent Document 1, switching is repeated per unit time from 10 seconds to 60 seconds. Thus, when a number of switching endurance limit was estimated at about 1,000,000 times, it is concern that the number of switching is might reach the number of endurance limit in few around several months.

Furthermore, if the high flow amount and the low flow amount are switched at a high frequency, the membrane is rapidly shaken and there is a concern that the membrane will be damaged. Thus, even a filtering method, in which though the frequency of the operation and the stopping of the blower or the switching of the valve decreases, the cleaning property of the membrane is required to be excellent, is required.

### SUMMARY OF THE INVENTION

An advantage of some aspects of the invention is that it provides a filtering method of the water to be treated in which the usage of air can be decreased and the membranes are sufficiently cleaned even though the frequency of the operation and the stopping of the blower or the switching of the valve decrease.

The present invention includes following aspects.

[1] A filtering method of water to be treated comprising: performing air diffusion from air diffusing units, while the water to be treated is processed with a filtering process using a membrane unit, wherein the filtering process is an intermittently performing filtering process, the membrane unit has two or more separation membrane modules, a membrane surface of the separation membrane modules has a flat shape and extends along a vertical direction, two or more air diffusing units are arranged in a lower-side direction of the membrane unit, the air diffusing units each has one or more air diffusing pipes, and when air is ejected from the air diffusing units, the air diffusing unit which ejects air is switched per a constant air diffusing time t₁ so as to allow only one air diffusing unit to eject air, and the air diffusing time t₁ is from 90 seconds to 300 seconds.

[2] The method according to above-mentioned [1], wherein each of the air diffusing pipes has a straight line shape and is arranged in parallel and horizontally so as to provide intervals between the adjacent air diffusing pipes,

the separation membrane modules are arranged at just above at least one of the intervals, and the adjacent air diffusing pipes constitute different air diffusing units.

[3] The method according to above-mentioned [1] or [2], the air diffusing time t₁ satisfies the following formula, and the air diffusing units are switched during a period from the filtering stopping to the filtering restarting.

t₁=(filtering time t₂+filtering stop time t₃)/nₐ

(wherein, nₐ is an even number of two or more; a filtering time t₂ means a period from start of filtration to stop of filtration; a filtering stop time t₃ means a period from stop of filtration to restart of filtration).

[4] The method according to above-mentioned [1] or [2], the air diffusing time t₁ satisfies the following formula.

t₁=(filtering time t₂+filtering stop time t₃)/n_{b}

(wherein, n_{b} is an odd number of three or more; t₂ means the period from start of filtration to stop of filtration; a filtering stop time t₃ means the period from stop of filtration to restart of filtration).

[5] The method according to any one of above-mentioned [1] to [4], one cycle of the air diffusing (wherein, one cycle of the air diffusing means a period from start of air diffusing from the air diffusing pipe to restart of air diffusing after stop of diffusing in each of air diffusing units) is from 180 seconds to 600 seconds.

According to the filtering method of the water to be treated of the invention, the usage of air can decrease and the membranes can be sufficiently cleaned even with decreasing the frequency of the operation and the stopping of the blower or the switching of the valve.

### BRIEF DESCRIPTION OF THE DRAWINGS

FIG. 1 is a diagram illustrating an embodiment of a filtering device that is used in a filtering method of the invention.

FIG. 2 is a perspective view illustrating an embodiment of a membrane unit that is a constituent of the filtering device shown in FIG. 1.

FIG. 3 is a perspective view illustrating an embodiment of an air diffusing device that is a constituent of the filtering device shown in FIG. 1.

FIG. 4 is a side view illustrating an embodiment of an arrangement of separation membrane modules and air diffusing pipes.

FIG. 5 is a top plan view illustrating an arrangement of first air diffusing pipes and second air diffusing pipes in the air diffusing device shown in FIG. 3.

FIG. 6 is a side view illustrating positions of air diffusing holes that are formed at the first air diffusing pipes or the second air diffusing pipes.

FIG. 7 is a drawing describing the period from after the lapse of [0.25× the filtering stop time t₃] from the filtering stopping to after the lapse of [0.75× the filtering stop time t₃] from the filtering stopping in the switching timing of the air diffusing unit.

FIG. 8 is a drawing describing the switching timing of the air diffusing unit.

FIG. 9 is a drawing describing the switching timing of the air diffusing unit.

FIG. 10 is a drawing describing the switching timing of the air diffusing unit.

FIG. 11 is a side view illustrating another embodiment of an arrangement of separation membrane modules and air diffusing pipes.

FIG. 12 is a top plan view illustrating a portion of another embodiment of the air diffusing device.

FIG. 13 is a side view illustrating a portion of another embodiment of the air diffusing device.

FIG. 14 is a graph illustrating a filtering differential pressure with respect to a filtering lapse time in Examples 1, 2, and 3.

FIG. 15 is a graph illustrating a filtering differential pressure with respect to a filtering lapse time in Example 4, and in Comparative Examples 1 and 2.

FIG. 16 is a graph illustrating a filtering differential pressure with respect to a filtering lapse time in Comparative Examples 3 and 4.

FIG. 17 is a graph illustrating a filtering differential pressure with respect to a filtering lapse time in Comparative Examples 5 and 6.

### DETAILED DESCRIPTION OF THE INVENTION

Hereinafter, preferred embodiments of the invention will be described; however, various modifications are possible within the scope of the claims and the below embodiments are not to be interpreted as restrictive.

### Filtering Device

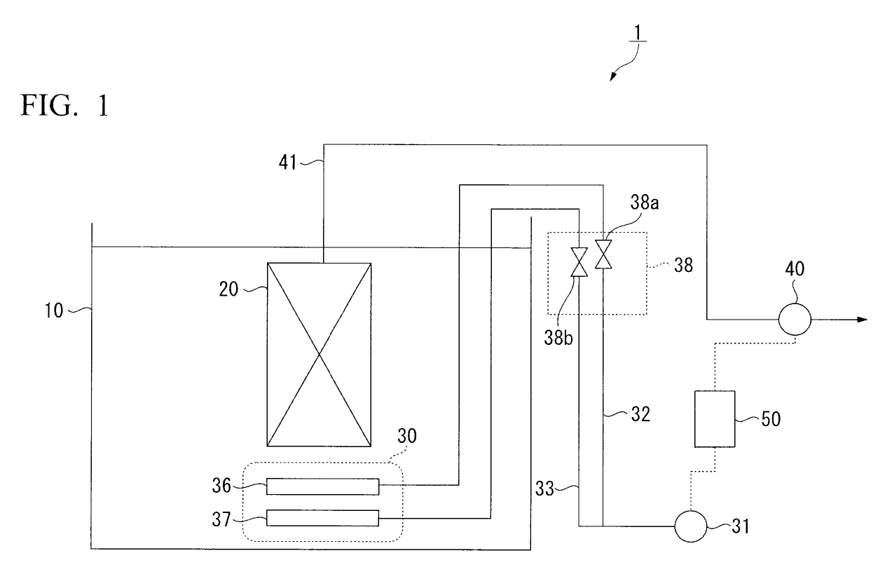

FIG. 1 is a diagram illustrating a filtering device in which a filtering method of an embodiment is applied. A filtering device 1 includes a treatment tank 10 in which sludge-containing water to be treated is stored, a membrane unit 20 that is provided within the treatment tank 10, an air diffusing device 30 that diffuses the air to the membrane unit 20, a filtering pump 40 that is connected to the membrane unit 20 through a suction pipe 41 and a control device 50 that controls the filtering pump 40.

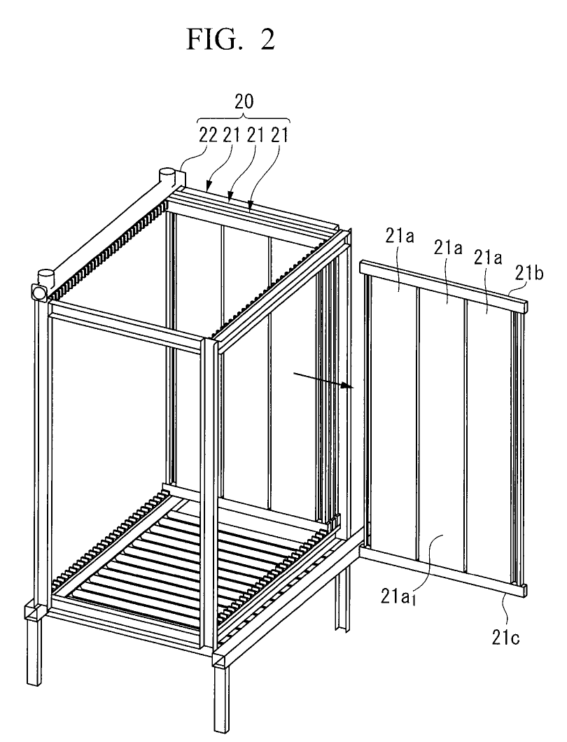

As shown in FIG. 2, the membrane unit 20 of the embodiment includes a plurality of separation membrane modules 21 having a flat plate shape; and a water collection header pipe 22 that is connected to the separation membrane module 21 and that collects water that passes through the separation membrane module 21.

The plurality of separation membrane modules 21 are arranged in parallel with a constant interval so that the adjacent membrane surfaces face each other. Each of the separation membrane modules 21 has a plurality of membrane sheets 21a in which the membrane surface 21a₁ extends along the vertical direction, a membrane sheet upper end fixing portion 21b that fixes the upper end of the membrane sheet 21a and a membrane sheet lower end fixing portion 21c that fixes the lower end of the membrane sheet 21a, and is arranged such that the membrane surfaces 21a₁ of each of the membrane sheets 21a are provided so as to keep the same side of membrane surface.

In the embodiment, the membrane sheet 21a is formed such that a plurality of hollow fiber membranes in which a plurality of micropores is formed at the surface thereof is arranged in parallel to each other.

The materials of the hollow fiber may be, for example, cellulose, polyolefin, polysulphone, ployvinylidene fluoride (PVDF), polytetrafluoroethylene (PTFE) and ceramics.

In the membrane unit 20, the interior of the water collection header pipe 22 and the interior of the membrane sheet upper end fixing portion 21b are hollow and communicated to the hollow portion of each of the hollow fibers membranes. Accordingly, the water to be treated that is filtered and entered in the hollow portion of the hollow fiber membrane is collected in the water collection header pipe 22 through the interior of the membrane sheet upper end fixing portion 21b.

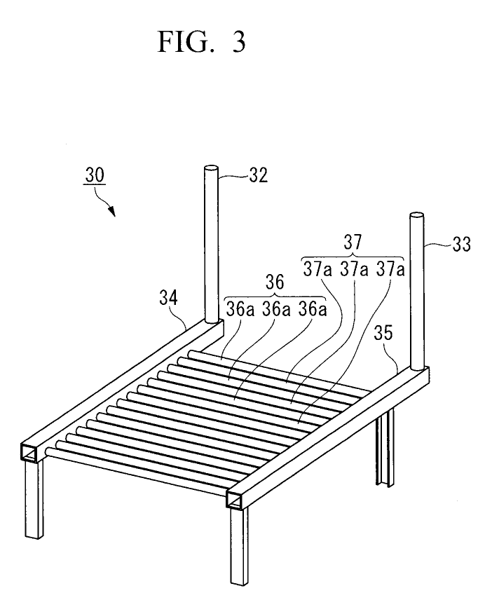

As shown in FIGS. 1 and 3, the air diffusing device 30 includes a blower 31, a first air supply pipe 32 and a second air supply pipe 33 that are connected to the blower 31 and provided along the vertical direction respectively, a first air branch pipe 34 having a rectangular pipe shape that is connected to the lower end of the first air supply pipe 32 and provided along the horizontal direction, a second air branch pipe 35 having a rectangular pipe shape that is connected to the lower end of the second air supply pipe 33 and provided along the horizontal direction, a first air diffusing unit 36 that has two or more first air diffusing pipes 36a having a straight line shape that is connected to the first air branch pipe 34, and a second air diffusing unit 37 that has two or more second air diffusing pipes 37a having a straight line shape that is connected to the second air branch pipe 35.

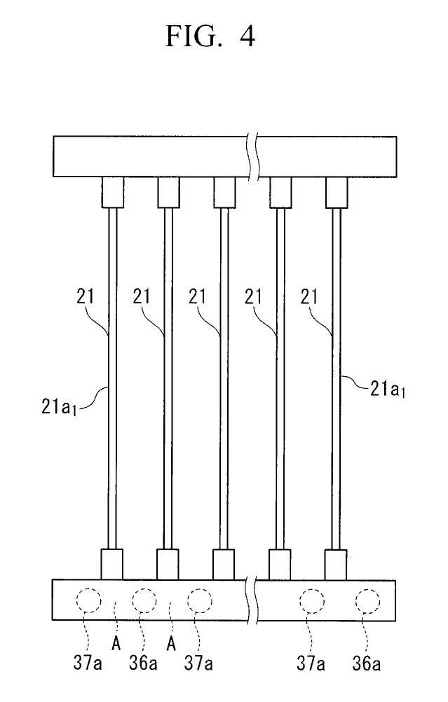

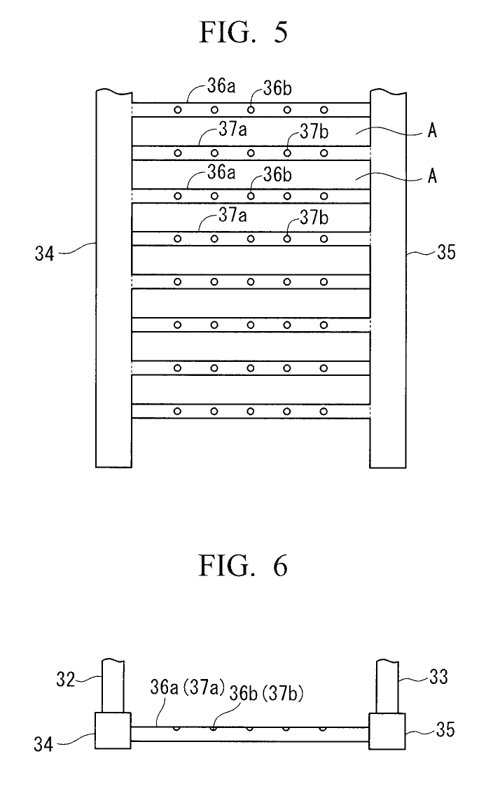

As shown in FIGS. 4 and 5, the first air diffusing pipe 36a is provided horizontally toward the second air branch pipe 35, and the second air diffusing pipe 37a is provided horizontally toward the first air branch pipe 34. The first air diffusing pipe 36a and the second air diffusing pipe 37a are alternately arranged horizontally with a constant interval, and an interval A is formed between the first air diffusing pipe 36a and the second air diffusing pipe 37a. In the embodiment, the separation membrane module 21 is provided just above each of the intervals A. In such an arrangement, the sum of the number of the first air diffusing pipes 36a and the number of the second air diffusing pipe 37a is greater than the number of the separation membrane modules 21.

As shown in FIG. 5, in the air diffusing device 30, the first air diffusing pipe 36a is fixed to the first air branch pipe 34 and the second air branch pipe 35. The interiors of the first air diffusing pipe 36a and the first air branch pipe 34 are communicated to each other; however, the interiors of the first air diffusing pipe 36a and the second air branch pipe 35 are not communicated to each other. The second air diffusing pipe 37a is fixed to the first air branch pipe 34 and the second air branch pipe 35. The interiors of the second air diffusing pipe 37a and the second air branch pipe 35 are communicated to each other; however, the interiors the second air diffusing pipe 37a and the first air branch pipe 34 are not communicated to each other.

As shown in FIG. 6, air diffusing holes 36b and 37b that are opened toward the upper direction are formed at the first air diffusing pipe 36a and the second air diffusing pipe 37a respectively. The diameter and number of the air diffusing holes 36b and 37b may be properly selected so as to sufficiently perform cleaning according to the size, type or the like of the separation membrane module 21.

In the air diffusing device 30 shown in FIGS. 1 and 3, the air that is supplied by a blower 31 is supplied to the first air diffusing pipe 36a through the first air supply pipe 32 and the first air branch pipe 34, and supplied to the second air diffusing pipe 37a through the second air supply pipe 33 and the second air branch pipe 35. However, the air that is supplied by the blower 31 is supplied only to any one of the first air supply pipe 32 and the second air supply pipe 33 by switching of a flow passage changeover valve 38 (38a and 38b) (for example, a rotary type valve or a reciprocating type valve). Accordingly, the air is ejected only from any one of the first air diffusing pipe 36a and the second air diffusing pipe 37a. The flow passage changeover valve 38 may have a two valves, 38a and 38b, or unite 38a and 38b into one valve 38.

### Filtering Method

In the filtering method using the filtering device 1, the filtering pump 40 is operated, the water to be treated is absorbed through the suction pipe 41 and the pressure in the interior of the hollow fiber membranes of the separation membrane module 21 becomes negative. When the interior of the hollow fiber membrane has a negative pressure, the water to be treated can pass through the micropores of the hollow fiber membrane but the sludge or the like that is larger than the micropore cannot pass through the micropores. Accordingly, the water to be treated can be filtered.

Simultaneously with the filtering, the blower 31 is controlled by the control device 50, the air is supplied to the first air diffusing unit 36 through the first air supply pipe 32 and the first air branch pipe 34, and the air is supplied to the second air diffusing unit 37 through the second air supply pipe 33 and the second air branch pipe 35. The air is ejected from the first air diffusing unit 36 or the second air diffusing unit 37 using the flow passage changeover valve 38. Furthermore, the air diffusing unit that ejects the air is switched per a constant air diffusing time t₁. Specifically, first of all, during the air diffusing time t₁, the air is ejected from the first air diffusing unit 36 without being ejected from the second air diffusing unit 37, and then the ejection of the air from the first air diffusing unit 36 stops, and, during the air diffusing time t₁, the air is ejected from the second air diffusing unit 37.

When the air is ejected from the first air diffusing unit 36 or the second air diffusing unit 37, air bubbles shake in the water to be treated and emerge therefrom. At this time, the mixed flow of the air and the liquid due to the air bubbles raises vicinity of the membrane surface 21a₁ of the separation membrane module 21 so that attached matter that is attached at the membrane surface 21a₁ can be separated therefrom.

Thus, the first air diffusing unit 36 and the second air diffusing unit 37 are repeatedly switched so that each of the membrane surfaces 21a₁ of the separation membrane module 21 is alternately cleaned.

It is preferable that the air diffusing time t₁ is 90 seconds or more and 300 seconds or less, and preferably 100 seconds or more and 180 seconds or less. The air diffusing time t₁ is preferably decreased from the viewpoint of the cleaning property of the membrane; however, if the air diffusing time t₁ is less than 90 seconds, the number of operations of the flow passage changeover valves 38 may be 960 times or more per day so that the flow passage changeover valve 38 may be easily damaged. If the air diffusing time t₁ is 90 seconds or more, shaking of the membrane sheet 21a is suppressed and the damage thereto can be prevented. Meanwhile, if the air diffusing time t₁ is 300 seconds or less, the membrane surface 21a₁ can be sufficiently cleaned. However, If the air diffusing time t₁ is over 300 seconds, the ascension rate of the filtering differential pressure may be increased, and thereby the stable filtering may not be performed.

It is preferable that the air diffusing from the air diffusing device 30 is continuously performed by any one of the first air diffusing unit 36 and the second air diffusing unit 37, but both the first air diffusing unit 36 and the second air diffusing unit 37 may stop air diffusing temporarily. However, during the filtering is performed for over 300 seconds in a state where the air diffusing stops, the amount of the sludge attachment to the membrane surface 21a₁ is increased, the attached sludge is difficult to remove even though the air diffusing restarts, and then there is a concern that the filtering differential pressure will be raised.

One cycle of air diffusing (wherein, one cycle of the air diffusing means a period from start of air diffusing from the air diffusing pipe to restart of air diffusing after stop of diffusing in each of air diffusing units), that is, the sum of air diffusing time t₁ and the air diffusing stop time is 180 seconds or more, and 600 seconds or less, from the viewpoint of the durability of a flow passage changeover valve and the filtering differential pressure. Moreover, it is more preferable that the sum of air diffusing time t₁ and the air diffusing stop time is 200 seconds or more, and 360 seconds or less.

In the filtering process, the filtering pump 40 is intermittently operated and then the filtering temporarily stops. The term “filtering time t₂” means a period from start of filtration to stop of filtration.

It is preferable that the filtering time t₂ is 30 minutes or less, and more preferable that it is 5 minutes or more and 20 minutes or less. If the filtering time t₂ is 30 minutes or less, since the sludge attachment to the membrane surface 21a₁ and clogging of the micropores is difficult to process, the sludge that is attached to the membrane surface 21a₁ can be further easily separated by the cleaning during the filtering stops.

Reverse washing by using washing water may be performed during a filtration stop time with regularly.

The term “reverse washing” means that the washing of membrane surface or inside of membrane by running washing water through from a second side of a separation membrane module to a first side of a separation membrane module. The washing water may be filtered water and tap water. Or, it may be solution including oxidizers such as sodium hypochlorite. Furthermore, the frequency of reverse washing and quantity of washing water may be arbitrarily set based on a flux at the time of filtration and a value of differential pressure rise voluntarily.

The term “filtering stop time t₃” means a period from stop of filtration to restart of filtration. It is preferable that the filtering stop time t₃ is 5 seconds or more and 600 seconds or less, and more preferable that it is 10 seconds or more and 300 seconds or less. If the filtering stop time t₃ is 5 seconds or more, the time for separating the sludge attached at the membrane surface 21a₁ can be sufficiently secured during the filtering stops and the cleaning property is further increased. As the filtering stop time t₃ is long, the cleaning property is further increased; however, if the filtering stop time t₃ is increased, the treatment amount per day is decreased. Thus, it is preferable that the filtering stop time t₃ is 600 seconds or less.

In the filtering method, it is preferable that the air diffusing time t₁ is set based on the filtering time t₂ and the filtering stop time t₃, and the switching of the first air diffusing unit 36 and the second air diffusing unit 37 is performed so that the air diffusing is not performed only with any one of the first air diffusing unit 36 and the second air diffusing unit 37 during the filtering stops. Since the cleaning property by the air diffusing is particularly excellent during the filtering stops, if the air diffusing is not performed only with any one of the first air diffusing unit 36 and the second air diffusing unit 37 during the filtering stops, both sides of membrane surface 21a₁ of the separation membrane module 21 can be evenly cleaned.

To ensure that the air diffusing is not performed only with any one of the first air diffusing unit 36 and the second air diffusing unit 37 during the filtering stops, specifically, it is preferable that a condition of air diffusion satisfies at least one condition selected from following (a) and (b).

(a) The air diffusing time t₁ satisfies the following formula,

t₁=(filtering time t₂+filtering stop time t₃)/nₐ

(wherein, nₐ is an even number of two or more; a filtering time t₂ means a period from start of filtration to stop of filtration; a filtering stop time t₃ means a period from stop of filtration to restart of filtration),
and the first air diffusing unit 36 and the second air diffusing unit 37 are switched in the period from the filtering stopping to the filtering restarting.

(b) The air diffusing time t₁ satisfies the following formula.

t₁=(filtering time t₂+filtering stop time t₃)/n_{b}

(wherein, n_{b} is an odd number of three or more; t₂ means the period from start of filtration to stop of filtration; a filtering stop time t₃ means the period from stop of filtration to restart of filtration).

Herein, “na” represents an odd number of times when the first air diffusing unit 36 and the second air diffusing unit 37 are switched in one cycle of filtering process, and “nb” represents an even number of times when the first air diffusing unit 36 and the second air diffusing unit 37 are switched in one cycle of filtering process. The term “one cycle of filtering process” means a period from start of filtration to restart of filtration after stop of filtration.

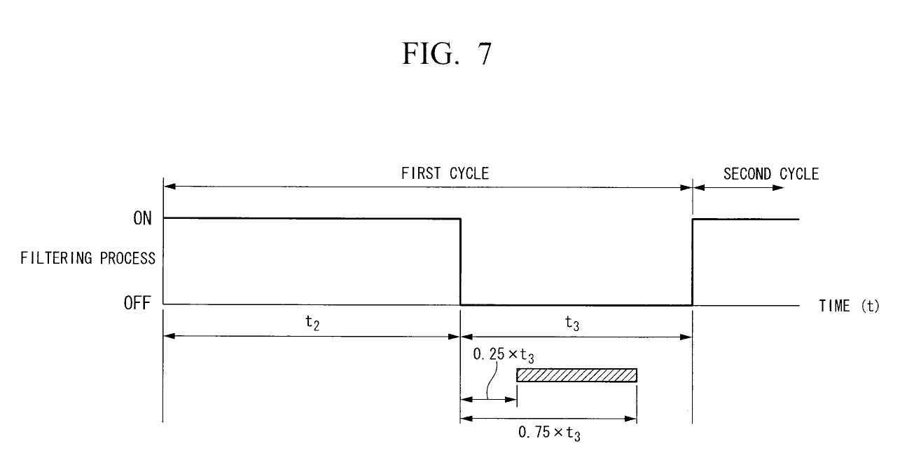

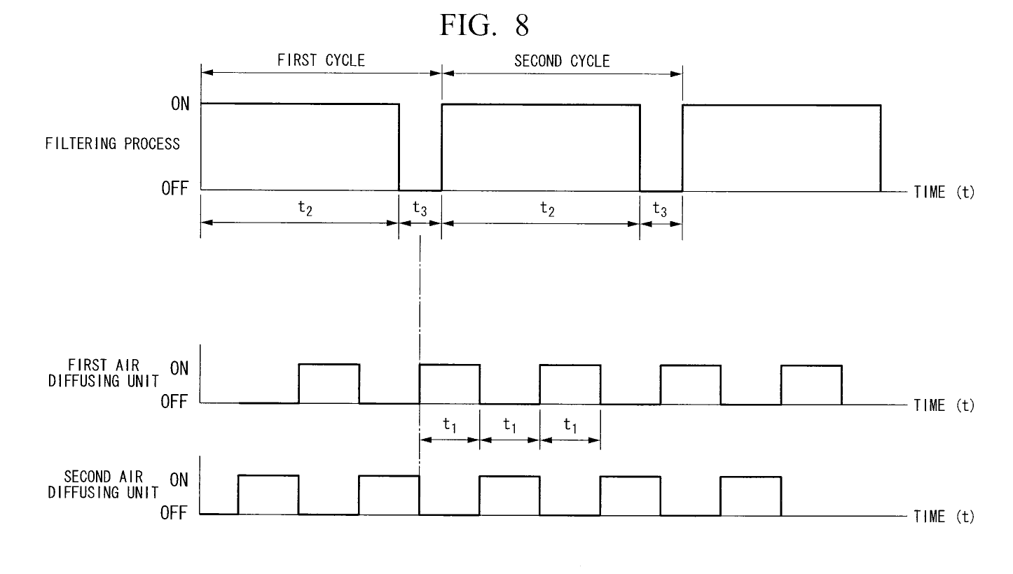

The timing at which the first air diffusing unit 36 and the second air diffusing unit 37 are switched is not restricted if the timing is in the period from the filtering stopping to the filtering starting in the above described (a); however, it is preferably in the period from after the lapse of [0.25× the filtering stop time t₃] from the filtering stopping up to after the lapse of [0.75× the filtering stop time t₃] from the filtering stopping (see FIG. 7), more preferably in the period from after the lapse of [0.3× the filtering stop time t₃] from the filtering stopping up to after the lapse of [0.7× the filtering stop time t₃] from the filtering stopping, and most preferably at after the lapse of [0.5× the filtering stop time t₃] from the filtering stopping (see FIG. 8).

If the timing at which the first air diffusing unit 36 and the second air diffusing unit 37 are switched is in the period from the filtering stopping to the filtering starting, both sides of surface of the separation membrane module 21 can be cleaned during the filtering stops. In other words, when the cleaning effect is increased, both sides of surface of the separation membrane module 21 are cleaned so that the cleaning property can be further increased.

If the timing at which the first air diffusing unit 36 and the second air diffusing unit 37 are switched is in the period from after the lapse of [0.25× the filtering stop time t₃] from the filtering stopping up to after the lapse of [0.75× the filtering stop time t₃] from the filtering stopping, each sides of the membrane surface 21a₁ of the separation membrane module 21 can be cleaned at least during the time of [0.25× the filtering stop time t₂] during the filtering stops.

If the timing at which the first air diffusing unit 36 and the second air diffusing unit 37 are switched is in the period from after the lapse of [0.5× the filtering stop time t₃] from the filtering stopping and nₐ is four, as shown in FIG. 8, each of sides of surface of the separation membrane module can be cleaned alternatively per [0.5× the filtering stop time t₃] by the first air diffusing unit 36 and the second air diffusing unit 37 during the filtering stops, in other words, when the cleaning effect is increased. As described above, if the cleaning is evenly performed by the first air diffusing unit 36 and the second air diffusing unit 37, the accumulation of the sludge to the membrane surface 21a₁ can be significantly suppressed when filtering stops.

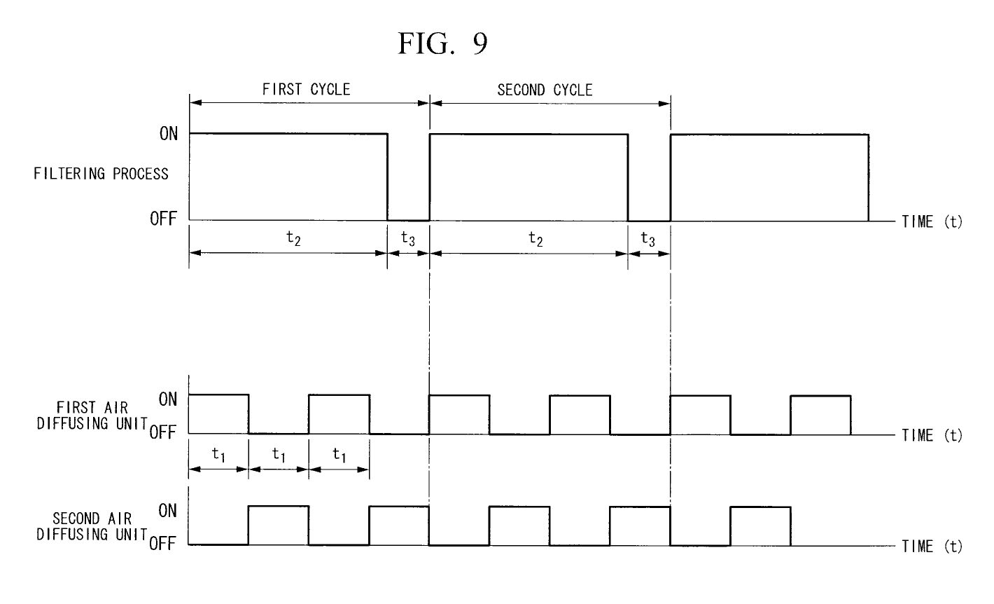

As shown in FIG. 9, during the filtering stops, only one air diffusing unit (the second air diffusing unit 37 in the illustrated embodiment) may be used to diffuse air; however, in this case, when the cleaning effect is increased, only one membrane surface 21a₁ of the separation membrane module 21 is cleaned and the other membrane surface 21a₁ is not cleaned. Thus, the cleaning of the other membrane surface 21a₁ is not sufficient, the sludge or the like is accumulated and causes clogging, and then the burden of the filtering using the one membrane surface 21a₁ is increased so that there is a concern that the clogging of the one membrane surface 21a₁ will be accelerated. Thus, both sides of membrane surface 21a₁ may be clogged in short period of time.

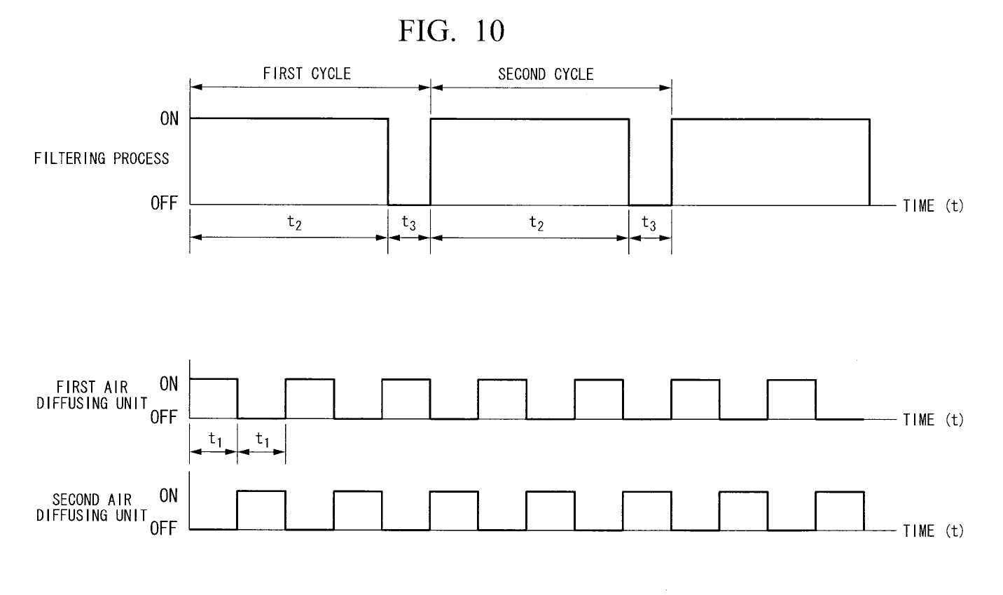

An embodiment of above-described (b) is illustrated in FIG. 10. In the embodiment of FIG. 10, nb=5.

In a cycle of the filtering process and a cycle of the air diffusing of the illustrated embodiment, one side of membrane surface 21a₁ of the separation membrane module 21 is cleaned by the first air diffusing unit 36 in the filtering stop time of the first cycle of the filtering process. Moreover, the other side of membrane surface 21a₁ of the separation membrane module 21 is cleaned by the second air diffusing unit 37 during the filtering stop time of the second cycle of the filtering process, and one side of membrane surface 21a₁ of the separation membrane module 21 is cleaned by the first air diffusing unit 36 again during the filtering stop time of the third cycle of the filtering process. In other words, in the filtering process, one side of membrane surface 21a₁ of the separation membrane module 21 is cleaned by the first air diffusing unit 36 during the filtering stop time of the odd number cycles and the other side of membrane surface 21a₁ of the separation membrane module 21 is cleaned by the second air diffusing unit 37 during the filtering stop time of the even number cycles.

Accordingly, during the filtering stops, each of the membrane surfaces 21a₁ of the separation membrane module 21 can be evenly cleaned by the first air diffusing unit 36 and the second air diffusing unit 37, and the accumulation of the sludge to the membrane surface 21a₁ can be further suppressed.

### <Functional Effect>

In the above-described filtering method, since the filtering process is intermittently performed, the filtering can be temporarily stopped. During the filtering stops, since the suction force from the interior of the membrane is not formed, the sludge that is attached at the membrane surface 21a₁ is easily separated. Thus, if the cleaning is performed by the diffused air during the filtering stop time, the cleaning property of the membrane surface 21a₁ is increased and then the filtering differential pressure can be easily recovered.

Furthermore, in the above-described filtering method, the air diffusing by the first air diffusing unit 36 and the air diffusing by the second air diffusing unit 37 are alternately repeated so that the separation membrane module 21 can be cleaned per each side of the membrane surfaces 21a₁. Additionally, during the filtering stop time, the air diffusing is not fixed at the first air diffusing unit 36 or the second air diffusing unit 37. Thus, both sides of membrane surface 21a₁ are sufficiently cleaned and the accumulation of the sludge at the membrane surface 21a₁ can be suppressed so that the filtering process can be performed for the long term without clogging the membrane surface 21a and the filtering process can be stably and sequentially performed.

### Other Embodiments

The invention is not limited to the above-described embodiments. For example, the membrane sheet 21a is not limited to the hollow fiber membranes being arranged in parallel to each other; if a filtering membrane that has a plurality of micropores is provided, all types of known separating membranes such as a flat membrane type, a pipe membrane type or a bag membrane type can be applied.

The air diffusing holes 36b and 37b of the first air diffusing pipe 36a and the second air diffusing pipe 37a may be formed so as to open toward the lower direction.

In the above-described embodiments, the first air diffusing pipe 36a of the first air diffusing unit 36 and the second air diffusing pipe 37a of the second air diffusing unit 37 are alternately arranged; however, the invention is not limited to this arrangement. For example, some of the air bubbles that are ejected from the air diffusing pipe arranged at the outermost side in the air diffusing device 30 are deviated from the separation membrane module 21 so that the cleaning of the membrane surface 21a₁ of the separation module 21 that is arranged at the outermost side is not sufficiently performed. Thus, an air diffusing unit may be arranged besides the first air diffusing unit 36 and the second air diffusing unit 37 which are arranged at the outermost side so as to continuously eject the air bubbles. If the air bubbles are continuously ejected, even though some of the air bubbles are deviated from the separation membrane module 21, the cleaning property of the membrane surface 21a₁ the separation module 21 that is arranged at the outermost side is not decreased.

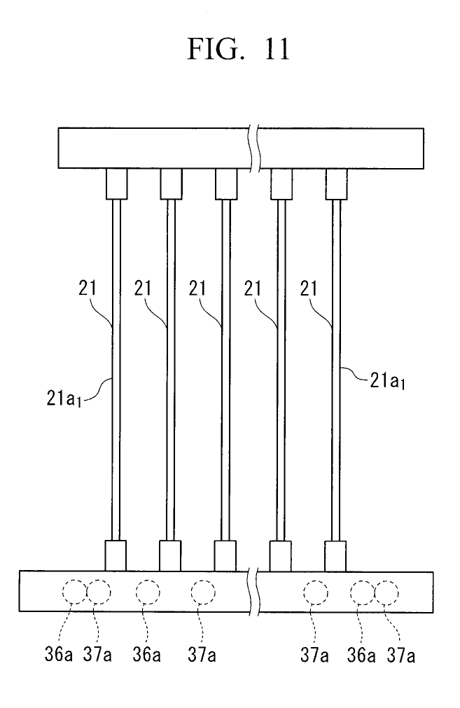

As shown in FIG. 11, the second air diffusing pipe 37a (or the first air diffusing pipe 36a) may be arranged adjacent to the first air diffusing pipe 36a (or the second air diffusing pipe 37a) that is arranged at the outermost side in the air diffusing device 30. In this case, the air bubbles that are ejected from the first air diffusing pipe 36a and the air bubbles that are ejected from the second air diffusing pipe 37a are made to contact alternatively at the membrane surface 21a₁ of the separation membrane module 21 that is arranged at the outermost side. Thus, the same effects as when the air bubbles are continuously ejected from the air diffusing pipe that is arranged at the outermost side are obtained.

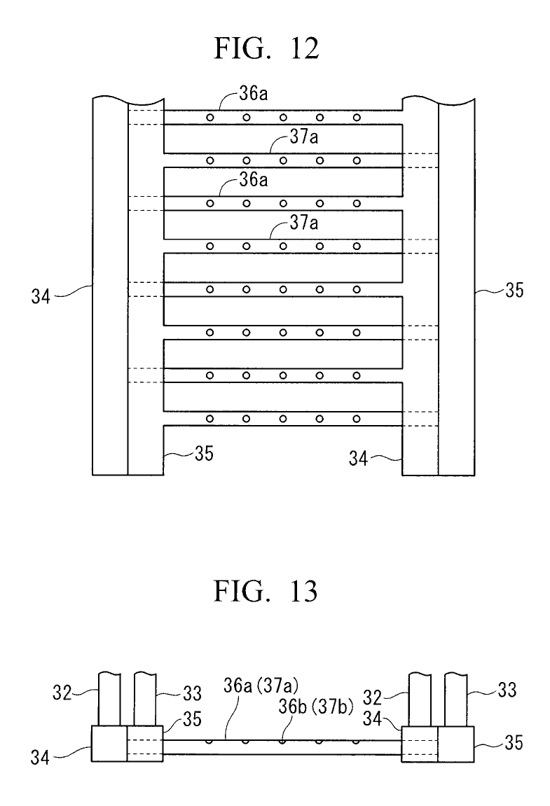

As shown in FIGS. 12 and 13, in the air diffusing device 30, the first air supply pipe 32 and the second air supply pipe 33 may be provided in twos respectively. In this case, the first air branch pipe 34 is connected to each of two first air supply pipes 32 and the second air branch pipe 35 is connected to each of two second air supply pipes 33. Both ends of each of the first air diffusing pipes 36a are connected to two first air branch pipes 34, and the interior of each of the first air diffusing pipes 36a and the interior of each of the first air branch pipes 34 are communicated to each other. The interior of each of first air diffusing pipes 36a are not communicated to the second air branch pipe 35.

Both ends of each of the second air diffusing pipes 37a are connected to the second air branch pipes 35, and the interior of each of the second air diffusing pipes 37a and the interior of each of the second air branch pipes 35 are communicated. The interior of each of second air diffusing pipes 37a are not communicated to the first air branch pipe 34.

In the air diffusing device 30, the air that is supplied from the first air supply pipe 32 is supplied to the first air diffusing pipe 36a through each of the first air branch pipes 34 from both ends thereof. The air that is supplied from the second air supply pipe 33 is supplied to the second air diffusing pipe 37a through each of the second air branch pipes 35 from both ends thereof.

The first air branch pipe 34 and the second air branch pipe 35 may be a rectangular pipe shape or may be a cylindrical shape.

The air diffusing device 30 has two air diffusing units; however, it may have three or more.

The air diffusing pipe need not be a straight shape and may be, for example, curved, bent or meandering. The air diffusing pipes need not be parallel to each other. Furthermore, the air diffusing pipe is not necessarily arranged horizontally.

The air diffusing pipes that are arranged adjacent to each other may partially be the same air diffusing unit.

### EXAMPLES

### Example 1

In the Example 1, as shown in FIG. 1, the filtering device 1 that includes the treatment tank 10, the membrane unit 20, the air diffusing device 30, the filtering pump 40 and the control device 50 is used.

As the membrane unit 20, a unit that includes eleven flat shape separation membrane modules in which the membrane surface extends along the vertical direction, and water collection header pipes that are attached to the separation membrane modules is used. As the separation membrane module, a hollow fiber membranes module (STERAPORE-SADF produced by MITSUBISHI RAYON CO., LTD.) is used in which polyvinylidene fluoride hollow fiber membranes for precision filtering having an average pore diameter of 0.4 μm are developed and fixed in a screen shape having the height of 2 m and the width of 1.2 m. Furthermore, the membranes are arranged in parallel to each other with a constant interval (the center interval between modules: 4.5 cm) so as to face each of the adjacent membrane surfaces.

As shown in FIG. 4, the separation membrane module 21 is provided just above between the first air diffusing pipe 36a and the second air diffusing pipe 37a as described below. The height difference between the bottom surface of the separation membrane module 21 and the first air diffusing pipe 36a and the second air diffusing pipe 37a is 150 mm.

As shown in FIGS. 3 and 5, as the air diffusing device 30, a device that includes the first air supply pipe 32, the second air supply pipe 33, the first air branch pipe 34, the second air branch pipe 35, the first air diffusing unit 36 and the second air diffusing unit 37 is used. The first air diffusing unit 36 having six first air diffusing pipes 36a and the second air diffusing unit 37 having six second air diffusing pipes 37a are used.

As the first air diffusing pipe 36a and the second air diffusing pipe 37a, a pipe that is a stainless pipe having an inner diameter of 20 mm and a length of 120 cm, and in which twenty two air diffusing holes 36b and 37b that are opened toward the upper direction and have a hole diameter of 4 mm are formed with an interval of 50 mm is used.

The water to be treated in which the solid content concentration (MLSS) is controlled to be between 8,000 to 10,000 mg/L is supplied to the treatment tank 10.

Next, the filtering pump 40 is intermittently operated and the filtering process is intermittently performed. The filtering flow speed LV=0.8 m³/m²/d, the filtering time t₂ is set to 420 seconds and the filtering stop time t₃ is set to 60 seconds.

The blower 31 is controlled by the control device 50, the air is supplied to the first air diffusing unit 36 through the first air supply pipe 32 and the first air branch pipe 34, and the air is supplied to the second air diffusing unit 37 through the second air supply pipe 33 and the second air branch pipe 35. The flow passage is switched by the flow passage changeover valve 38 so that the air is ejected from the first air diffusing unit 36 or the second air diffusing unit 37, and the air diffusing unit that ejects the air is switched per a constant air diffusing time t₁. The switching of the first air diffusing unit 36 and the second air diffusing unit 37 is repeated so that each of the membrane surfaces 21a₁ of the separation membrane module 21 is alternately cleaned.

The flow amount of air of 130 L/min is supplied to each of air diffusing pipes 36a and 37a. Since each of the air diffusing units 36 and 37 has six air diffusing pipes 36a and 37a respectively, the flow amount of air of 80 L/min is supplied to the air diffusing units 36 and 37. The air diffusing time t₁ is set to 90 seconds.

Aeration magnification in this example is 5.1. The term “Aeration magnification” means a value that is calculated by dividing an amount of air supply per unit of time by quantity of filtrate water per unit of time)

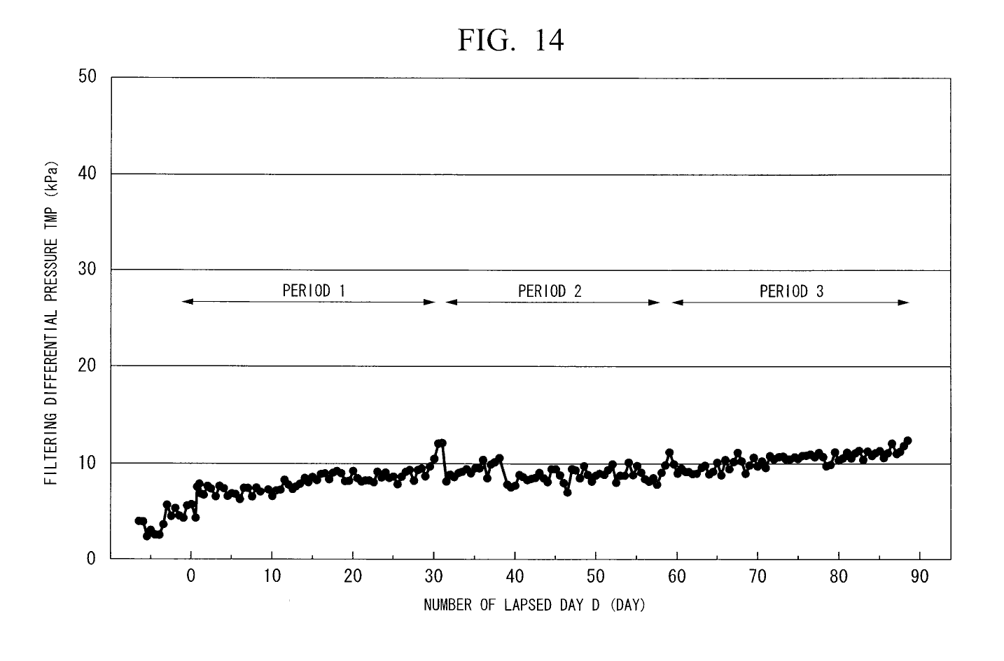

Under the above-described conditions, the water to be treated is filtered for 28 days and the filtering differential pressure is measured. The change of the filtering differential pressure over time is illustrated in period 1 in FIG. 14. The transverse axis is the number of lapsed days D (day) and the vertical axis is the filtering differential pressure TMP (kPa) in FIG. 14.

In this example, the average of increasing rate of the filtering differential pressure is 0.16 kPa/day, the filtering differential pressure is substantially constant and stable filtering can be performed. The attachment of the sludge to the membrane surface 21a₁ is not identified when the membrane surface 21a₁ of the separation membrane module 21 is visually inspected, after the filtering finishes.

The term “average of increasing rate of the filtering differential pressure” represents the value calculated by following formula.

{[filtering differential pressure at the end of the test (kPa)]−[filtering differential pressure at the beginning of the test (kPa)]}/[number of days of test (day)]

### Example 2

The water to be treated is filtered in the same manner as that of the Example 1 except the filtering time t₂ is set to 420 seconds, the filtering stop time t₃ is set to 60 seconds and the air diffusing time t₁ is set to (t₂+t₃)/4=120 seconds.

Under the above-described conditions, the water to be treated is filtered for 26 days and then the filtering differential pressure is measured. The change of the filtering differential pressure over time is illustrated in period 2 in FIG. 14.

In this example, the average of increasing rate of the filtering differential pressure is 0.14 kPa/day, the filtering differential pressure is substantially constant and stable filtering can be performed. The attachment of the sludge to the membrane surface 21a₁ is not identified when the membrane surface 21a₁ of the separation membrane module 21 is visually inspected, after the filtering finishes.

### Example 3

The water to be treated is filtered in the same manner as that of the Example 2 except the air diffusing unit is switched after the lapse of ½ of the filtering stop time t₃ from the filtering stop (in other words, after 30 seconds from the filtering stop).

Under the above-described conditions, the water to be treated is filtered for 21 days and then the filtering differential pressure is measured. The change of the filtering differential pressure over time is illustrated in period 3 in FIG. 14.

In this example, the average of increasing rate of the filtering differential pressure is 0.08 kPa/day, the filtering differential pressure is substantially constant and stable filtering can be performed. The attachment of the sludge to the membrane surface 21a₁ is not identified when the membrane surface 21a₁ of the separation membrane module 21 is visually inspected, after the filtering finishes.

### Comparative Example 1

The water to be treated is filtered in the same manner as that of the Example 2 except the first air diffusing unit 36 and the second air diffusing unit 37 are not switched at per a constant air diffusing time t₁ and the air is continuously diffused from both of the first air diffusing pipe 36a and the second air diffusing pipe 37a.

That is, aeration magnification in this example is 10.2.

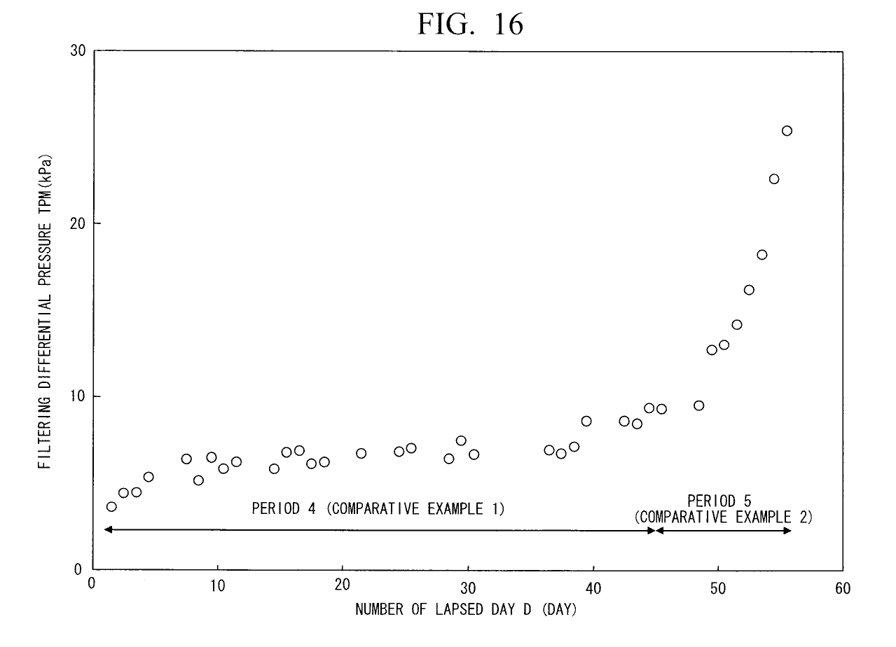

Under the above-described conditions, the water to be treated is filtered for 45 days and the filtering differential pressure is measured. The change of the filtering differential pressure over time is illustrated in a period 4 in FIG. 16.

In this comparative example, the average of increasing rate of the filtering differential pressure is 0.13 kPa/day, the filtering differential pressure is substantially constant and stable filtering can be performed. The attachment of the sludge to the membrane surface 21a₁ is not identified when the membrane surface 21a₁ of the separation membrane module 21 is visually inspected, after the filtering finishes.

### Comparative Example 2

The water to be treated is filtered in the same manner as that of the Example 2 except the first air diffusing unit 36 and the second air diffusing unit are not switched at per a constant air diffusing time t₁ and the air is continuously diffused from both of the first air diffusing pipe 36a and the second air diffusing pipe 37a

That is, aeration magnification in this example is 5.1.

Under the above-described conditions, the water to be treated is filtered for 12 days and the filtering differential pressure is measured. The change of the filtering differential pressure over time is illustrated in a period 5 in FIG. 16.

In the example, the initial filtering differential pressure is 9.3 kPa, the filtering differential pressure is 25.4 kPa after 12 days.

In this comparative example, the average of increasing rate of the filtering differential pressure is 1.3 kPa/day, and a stable filtering cannot be performed. The attachment of the sludge to the membrane surface 21a₁ is identified when the membrane surface 21a₁ of the separation membrane module 21 is visually inspected, after the filtering stops.

### Example 4

In the Example 4, as shown in FIG. 1, the filtering device 1 that includes the treatment tank 10, the membrane unit 20, the air diffusing device 30, the filtering pump 40 and the control device 50 is used.

As the membrane unit 20, a unit that includes five flat shape separation membrane modules in which the membrane surface is along the vertical direction, and water collection header pipes that are attached to the separation membrane modules is used. As the separation membrane module, a hollow fiber membranes module (STERAPORE-SADF produced by MITSUBISHI RAYON CO., LTD.) is used in which polyvinylidene fluoride hollow fiber membranes for precision filtering having an average pore diameter of 0.4 μm are developed and fixed in a screen shape having a height of 1 m and a width of 0.6 m. Furthermore, the membranes are arranged in parallel to each other with a constant interval (the center interval between modules: 4.5 cm) so as to face each of the adjacent membrane surfaces is used.

As shown in FIG. 4, the separation membrane module 21 is provided just above between the first air diffusing pipe 36a and the second air diffusing pipe 37a as described below. The height difference between the bottom surface of the separation membrane module 21 and the first air diffusing pipe 36a and the second air diffusing pipe 37a is 150 mm.

As shown in FIGS. 3 and 5, as the air diffusing device 30, a device that includes the first air supply pipe 32, the second air supply pipe 33, the first air branch pipe 34, the second air branch pipe 35, the first air diffusing unit 36 and the second air diffusing unit 37 is used. The first air diffusing unit 36 has three first air diffusing pipes 36a and the second air diffusing unit 37 has three second air diffusing pipes 37a.

As the first air diffusing pipe 36a and the second air diffusing pipe 37a, a pipe that is made of polyvinyl chloride having an inner diameter of 20 mm and a length of 60 cm, and in which ten air diffusing holes 36b and 37b that are opened toward the upper direction and have a hole diameter of 4 mm are formed with an interval of 50 mm is used.

Water to be treated in which the solid content concentration (MLSS) is controlled to be between 10,000 to 120,000 mg/L is supplied to the treatment tank 10.

Next, the filtering pump 40 is intermittently operated and the filtering process is intermittently performed. The filtering flow speed LV=0.8 m³/m²/d, the filtering time t₂ is 420 seconds and the filtering stop time t₃ is 60 seconds.

The blower 31 is controlled by the control device 50, the air is supplied to the first air diffusing unit 36 through the first air supply pipe 32 and the first air branch pipe 34 and the air is supplied to the second air diffusing unit 37 through the second air supply pipe 33 and the second air branch pipe 35. The flow passage is switched by the flow passage changeover valve so that the air is ejected from the first air diffusing unit 36 or the second air diffusing unit 37, and the air diffusing unit that ejects the air is switched per a constant air diffusing time t₁. The switching of the first air diffusing unit 36 and the second air diffusing unit 37 is repeated so that each sides of the membrane surface 21a₁ of the separation membrane module 21 is alternately cleaned.

The flow amount of air regulated at 60 L/min is supplied to each of air diffusing pipes 36a and 37a. Since each of the air diffusing units 36 and 37 has three air diffusing pipes 36a and 37a respectively, a flow amount of air of 180 L/min is supplied to each of the air diffusing units 36 and 37. The air diffusing time t₁ is 160 seconds.

In this example, aeration magnification is 21.6.

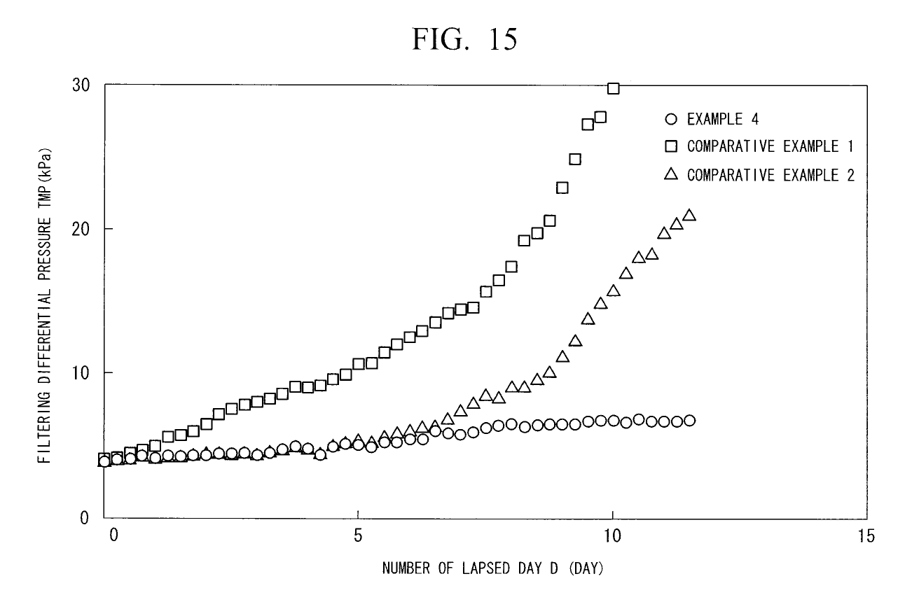

Under the above-described conditions, the water to be treated is filtered for 12 days and the filtering differential pressure is measured. The change of the filtering differential pressure over time is illustrated in FIG. 15. The transverse axis is the number of lapsed days D (day) and the vertical axis is the filtering differential pressure TMP (kPa) in FIG. 15.

In this example, the initial filtering differential pressure is 3.5 kPa, the filtering differential pressure is 6.8 kPa after twelve days. In this example, the average of increasing rate of the filtering differential pressure is 0.28 kPa/day, and then a stable filtering can be performed. The attachment of the sludge to the membrane surface 21a₁ is not identified when the membrane surface 21a₁ of the separation membrane module 21 is visually inspected, after the filtering stops.

### Comparative Example 3

The water to be treated is filtered in the same manner as that of the Example 4 except the first air diffusing unit 36 and the second air diffusing unit 37 are not switched per a constant air diffusing time t₁ and the air is continuously ejected from both of the first air diffusing pipe 36a and the second air diffusing pipe 37a.

That is, the air regulated at 30 L/min is supplied to each of air diffusing pipes.

In this comparative example, aeration magnification is 21.6.

Under the above-described conditions, the water to be treated is filtered for 10 days and the filtering differential pressure is measured. The change of the filtering differential pressure by time is illustrated in FIG. 15.

In the example, initial filtering differential pressure is 3.8 kPa, the filtering differential pressure is 29.8 kPa after ten days. In this example, the average of increasing rate of the filtering differential pressure is 2.6 kPa/day that is high value, and a stable filtering cannot be performed. The attachment of the sludge to the membrane surface 21a, is identified when the membrane surface 21a₁ of the separation membrane module 21 is visually inspected, after the filtering stops.

### Comparative Example 4

The water to be treated is filtered in the same manner as that of the Example 4 except the air regulated at 60 L/min is supplied to each of air diffusing pipes.

In this example, aeration magnification is 43.2.

Under the above-described conditions, the water to be treated is filtered for 10 days and the filtering differential pressure is measured. The change of the filtering differential pressure by time is illustrated in FIG. 15.

In the comparative example, initial filtering differential pressure is 3.8 kPa, the filtering differential pressure is 21.1 kPa after ten days.

In this comparative example, the average of increasing rate of the filtering differential pressure is high value 1.7 kPa/day, and a stable filtering cannot be performed. The attachment of the sludge to the membrane surface 21a₁ is identified when the membrane surface 21a₁ of the separation membrane module 21 is visually inspected, after the filtering stops.

### Comparative Example 5

The water to be treated is filtered in the same manner as that of the Example 4 except t1 is set to 600 seconds.

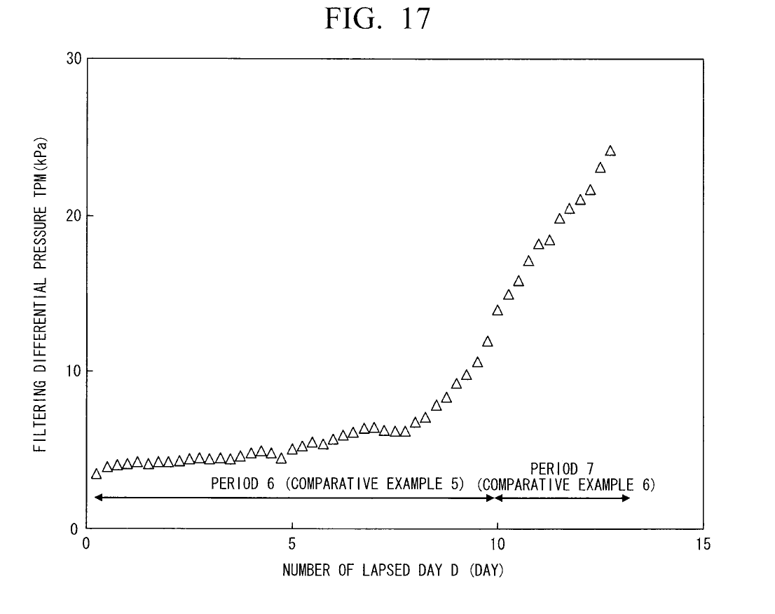

Under the above-described conditions, the water to be treated is filtered for 10 days and the filtering differential pressure is measured. The change of the filtering differential pressure by time is illustrated in FIG. 17 (period 6).

In the comparative example, initial filtering differential pressure is 3.5 kPa, the filtering differential pressure is 7.9 kPa after 10 days.

In this example, the average of increasing rate of the filtering differential pressure is high value 0.44 kPa/day, and a stable filtering cannot be performed.

A small quantity of attachment of the sludge to the membrane surface 21a₁ is identified when the membrane surface 21a₁ of the separation membrane module 21 is visually inspected, after the filtering stops.

### Comparative Example 6

The water to be treated is filtered in the same manner as that of the Example 4 except t1 is set to 720 seconds.

Under the above-described conditions, the water to be treated is filtered for 4 days and the filtering differential pressure is measured. The change of the filtering differential pressure by time is illustrated in FIG. 17 (period 7).

In the example, initial filtering differential pressure is 10.7 kPa, the filtering differential pressure is 24.1 kPa after 4 days.

In this comparative example, the average ascension rate of the filtering differential pressure is 3.4 kPa/day that is high value, and a stable filtering cannot be performed.

The attachment of the sludge to the membrane surface 21a₁ is identified when the membrane surface 21a₁ of the separation membrane module 21 is visually inspected, after the filtering stops.

The results of Examples 1 to 4, and Comparative Examples 1 to 6 are shown in Table 1.

TABLE 1

| | | | | | average ascension rate | |
|---|---|---|---|---|---|---|
| | t1 | t2 | t3 | | of the filtering | |
| | air diffusing time | filtering time | filtering stop time | Aeration magnification | differential pressure | |
| | (sec) | (sec) | (sec) | (m3/m3) | (kPa/day) | stable filtering |
| Example 1 | 90 | 420 | 60 | 5.1 | 0.16 | possible |
| Example 2 | 120 | 420 | 60 | 5.1 | 0.14 | possible |
| Example 3 | 120 | 420 | 60 | 5.1 | 0.08 | possible |
| Example 4 | 160 | 420 | 60 | 21.6 | 0.28 | possible |
| Comparative Example 1 | continuous diffusing | 420 | 60 | 10.2 | 0.13 | possible |
| Comparative Example 2 | continuous diffusing | 420 | 60 | 5.1 | 1.3 | impossible |
| Comparative Example 3 | continuous diffusing | 420 | 60 | 21.6 | 2.6 | impossible |
| Comparative Example 4 | continuous diffusing | 420 | 60 | 43.2 | 1.7 | impossible |
| Comparative Example 5 | 600 | 420 | 60 | 21.6 | 0.44 | impossible |
| Comparative Example 6 | 720 | 420 | 60 | 21.6 | 3.4 | impossible |

### INDUSTRIAL APPLICABILITY

According to the filtering method of the water to be treated of the invention, the usage of air can decrease and the membranes can be sufficiently cleaned even with decreasing the frequency of the operation and the stopping of the blower or the switching of the valve.

### DESCRIPTION OF THE REFERENCE SYMBOLS

1. filtering device
10. treatment tank
20. membrane unit
21. separation membrane module
21a. membrane sheet
21b. membrane sheet upper end fixing portion
21c. membrane sheet lower end fixing portion
22. water collection header pipe
30. air diffusing device
31. blower
32. first air supply pipe
33. second air supply pipe
34. first air branch pipe
35. second air branch pipe
36. first air diffusing unit
36a. first air diffusing pipe
37. second air diffusing unit
37a. second air diffusing pipe
40. filtering pump
41. suction pipe
50. control device

1. A filtering method of water to be treated comprising:
performing air diffusion from air diffusing units, while the water to be treated is processed with a filtering process using a membrane unit, wherein
the filtering process is an intermittently performing filtering process,
the membrane unit has two or more separation membrane modules,
a membrane surface of the separation membrane modules has a flat shape and extends along a vertical direction,
two or more air diffusing units are arranged in a lower-side direction of the membrane unit,
the air diffusing units each has one or more air diffusing pipes, and
when air is ejected from the air diffusing units, the air diffusing unit which ejects air is switched per a constant air diffusing time t₁ so as to allow only one air diffusing unit to eject air, and the air diffusing time t₁ is from 90 seconds to 300 seconds.

2. The method according to claim 1, wherein
each of the air diffusing pipes has a straight line shape and is arranged in parallel and horizontally so as to provide intervals between the adjacent air diffusing pipes,
the separation membrane modules are arranged at just above at least one of the intervals, and
the adjacent air diffusing pipes constitute different air diffusing units.

3. The method according to claim 1, wherein
the air diffusing time t₁ satisfies the following formula, and the air diffusing units are switched during a period from the filtering stopping to the filtering restarting.
t₁=(filtering time t₂+filtering stop time t₃)/nₐ
(wherein, nₐ is an even number of two or more; a filtering time t₂ means a period from start of filtration to stop of filtration; a filtering stop time t₃ means a period from stop of filtration to restart of filtration).

4. The method according to claim 1, wherein
the air diffusing time t₁ satisfies the following formula.
t₁=(filtering time t₂+filtering stop time t₃)/n_{b}
(wherein, n_{b} is an odd number of three or more; t₂ means the period from start of filtration to stop of filtration; a filtering stop time t₃ means the period from stop of filtration to restart of filtration).

5. The method according to claim 1, wherein
one cycle of the air diffusing (wherein, one cycle of the air diffusing means a period from start of air diffusing from the air diffusing pipe to restart of air diffusing after stop of diffusing in each of air diffusing units) is from 180 seconds to 600 seconds.

6. The method according to claim 2, wherein
the air diffusing time t₁ satisfies the following formula, and the air diffusing units are switched during a period from the filtering stopping to the filtering restarting.
t₁=(filtering time t₂+filtering stop time t₃)/nₐ
(wherein, nₐ is an even number of two or more; a filtering time t₂ means a period from start of filtration to stop of filtration; a filtering stop time t₃ means a period from stop of filtration to restart of filtration).

7. The method according to claim 2, wherein
the air diffusing time t₁ satisfies the following formula.
t₁=(filtering time t₂+filtering stop time t₃)/n_{b}
(wherein, n_{b} is an odd number of three or more; t₂ means the period from start of filtration to stop of filtration; a filtering stop time t₃ means the period from stop of filtration to restart of filtration).

8. The method according to claim 2, wherein
one cycle of the air diffusing (wherein, one cycle of the air diffusing means a period from start of air diffusing from the air diffusing pipe to restart of air diffusing after stop of diffusing in each of air diffusing units) is from 180 seconds to 600 seconds.

9. The method according to claim 3, wherein
one cycle of the air diffusing (wherein, one cycle of the air diffusing means a period from start of air diffusing from the air diffusing pipe to restart of air diffusing after stop of diffusing in each of air diffusing units) is from 180 seconds to 600 seconds.

10. The method according to claim 4, wherein
one cycle of the air diffusing (wherein, one cycle of the air diffusing means a period from start of air diffusing from the air diffusing pipe to restart of air diffusing after stop of diffusing in each of air diffusing units) is from 180 seconds to 600 seconds.

11. The method according to claim 6, wherein
one cycle of the air diffusing (wherein, one cycle of the air diffusing means a period from start of air diffusing from the air diffusing pipe to restart of air diffusing after stop of diffusing in each of air diffusing units) is from 180 seconds to 600 seconds.

12. The method according to claim 7, wherein
one cycle of the air diffusing (wherein, one cycle of the air diffusing means a period from start of air diffusing from the air diffusing pipe to restart of air diffusing after stop of diffusing in each of air diffusing units) is from 180 seconds to 600 seconds.
